(19) United States
(12) Patent Application Publication
(10) Pub. No.: US 2012/0151770 A1
(43) Pub. Date: Jun. 21, 2012

(54) TRUSS ASSEMBLY APPARATUS

(75) Inventor: Charles J. Davies, Pasadena, CA (US)

(73) Assignee: GLOBAL TRUSS AMERICA, LLC, Los Angeles, CA (US)

(21) Appl. No.: 13/394,139

(22) PCT Filed: Sep. 3, 2010
(86) PCT No.: PCT/US10/47905

§ 371 Date: Mar. 2, 2012

Related U.S. Application Data
(60) Provisional application No. 61/240,082, filed on Sep. 4, 2009.

(51) Int. Cl. B25B 27/00; B23P 11/00

(52) U.S. Cl. 29/897.3; 29/268; 29/426.5

(57) ABSTRACT

The present invention provides a truss assembly apparatus and method for coupling truss members. The apparatus comprises a first lever and second lever joined at a joint mechanism. The first lever comprises a handle at one end and a first head at another end. The second lever also comprises a handle at one end and a second head at another end. The second head further comprises a second tip for engaging a head of a truss pin. Additionally, the first head comprises a first tip which is substantially curved in profile and capable of both receiving and supporting the walls of a truss member. The first tip further comprises an opening such as a slot allowing for at least the tip of the pin to pass therethrough.

### CROSS REFERENCE TO RELATED APPLICATIONS

This application claims priority to U.S. Provisional Patent Application Ser. No. 61/240,082 filed Sep. 4, 2009, incorporated herein by reference in its entirety.

### BACKGROUND OF THE INVENTION

1. Field of the Invention

The present invention relates generally to truss systems, and in particular, to a truss assembly apparatus.

2. Description of Related Art

Trusses provide general purpose skeletal structures designed to support lighting and audio equipment for live stages, theatres, night clubs, church installations, and other mobile applications. Trusses generally include a variety of different modular truss elements or members that can be interconnected to build structures of different shapes and forms by a designer to independently create whichever lighting, audio, or other affect or appearance may be desired.

Typically, each of the truss members are modular and can be connected together and dismantled quickly. The modular members may include square truss members, triangular truss members, I-beam truss members, clamps, box truss members, circular truss members, lifts/lifters, junction blocks, truss corners, towers, sleeve blocks, couplers and clamps among others. The truss members generally run about 0.5 meters in length and are either straight lengths or circular arcs and have connectors to mate the members together.

Oftentimes the same structure must be recreated many times in different places. For example, in a rock and roll touring show the truss work and stage effects must be created and recreated in different places along the tour. On other occasions, the structures are created once and then dismantled. For example, a trade show or political convention will be designed in a particular manner for a particular venue and for an audience at the venue. Then, once the show or convention is complete, the trusses are dismantled and the members are reused in other applications later. In any case, once the trusses are in place they must also be strong and permanent for usage without concerns about the structural performance while they are in place.

### BRIEF SUMMARY OF THE INVENTION

Embodiments of the present invention provide an apparatus and method for assembling truss members together. In one embodiment of the present invention, the apparatus comprises a first lever and a second lever joined at a joint mechanism (pivot pin), with the pivot pin residing closer to one end of the levers. The first lever further comprises a handle at one end, and a first head at another end, wherein the pivot pin resides closer to the first head. The second lever also comprises a handle at one end, and a second head at another end, wherein the pivot pin resides closer to the second head. In one embodiment, the handles are similar in shape, dimension, and reside towards the same end from the pivot pin.

The first head further comprises a first tip for engaging a head of a truss pin. Additionally, the second head comprises a second tip for supporting a truss member. The second tip is substantially curved in profile and capable of both receiving and supporting the walls of a truss member. The second tip further comprises an opening such as a slot allowing for at least the tip of the pin to pass there through.

The length of the handles may be selected depending on the leveraging force desired for driving the truss pin through holes in the truss member. The shape and size of the tips may be selected to accommodate different truss member shapes and sizes. Further, the handles may be of the adjustable ratchet type, slip joint type, groove joint or tongue-and-groove type, etc., which allow adjusting the length of the handles relative to the pivot pin, or adjusting distance of the heads for different leverage requirements.

### BRIEF DESCRIPTION OF THE DRAWINGS

FIG. 1A illustrates two disconnected truss pieces capable of interconnecting to form a truss member, according to an embodiment of the present invention.

FIG. 1B illustrates a perspective view of two interconnected truss pieces forming a truss member, according to an embodiment of the present invention.

FIG. 1C illustrates a perspective view of a truss assembly apparatus, according to an embodiment of the present invention.

FIG. 1D illustrates an alternative perspective view of the truss assembly apparatus engaging a truss member and a truss pin, according to an embodiment of the present invention.

FIG. 2 illustrates a side view of the truss assembly apparatus engaging the truss member and the truss pin, according to an embodiment of the present invention.

FIG. 3A illustrates a front view of the truss assembly apparatus engaging the truss member and the truss pin, according to an embodiment of the present invention.

FIG. 3B illustrates an alternative front view of the truss assembly apparatus, according to an embodiment of the present invention.

FIG. 3C illustrates a bottom view of the truss assembly apparatus, according to an embodiment of the present invention.

FIG. 4 illustrates an alternative side view of the truss assembly apparatus, according to an embodiment of the present invention.

FIG. 5 illustrates a front view the truss assembly apparatus engaging the truss member and the truss pin, according to an embodiment of the present invention.

FIG. 6 illustrates a process for coupling two truss pieces using the truss assembly apparatus, according to an embodiment of the present invention.

FIG. 7 illustrates a process for de-coupling two truss pieces using the truss assembly apparatus, according to an embodiment of the present invention.

### DETAILED DESCRIPTION OF THE INVENTION

The following description is made for the purpose of illustrating the general principles of the present invention and is not meant to limit the inventive concepts claimed herein. Further, particular features described within can be used in combination with other described features in each of the various possible combinations and permutations. Unless otherwise specifically defined herein, all terms should be given their broadest possible interpretation including meanings implied from the specification as well as meanings understood by those skilled in the art and/or as defined in dictionaries, treatises, etc.

Embodiments of the present invention provide a truss assembly device, comprising a first lever and a second lever coupled together about a joint mechanism, the first lever comprising a first handle residing at one end of the first lever and a first head residing at another end of the first lever. The second lever comprising a second handle residing at one end of the second lever and a second head residing at another end of the second lever. Wherein the first head is substantially curved in a concave-upward profile configured for receiving a truss member and wherein the second head is configured for engaging and driving a truss assembly pin through holes in the truss member when the first lever and the second lever move towards each other thereby causing the first head and the second head to move towards each other.

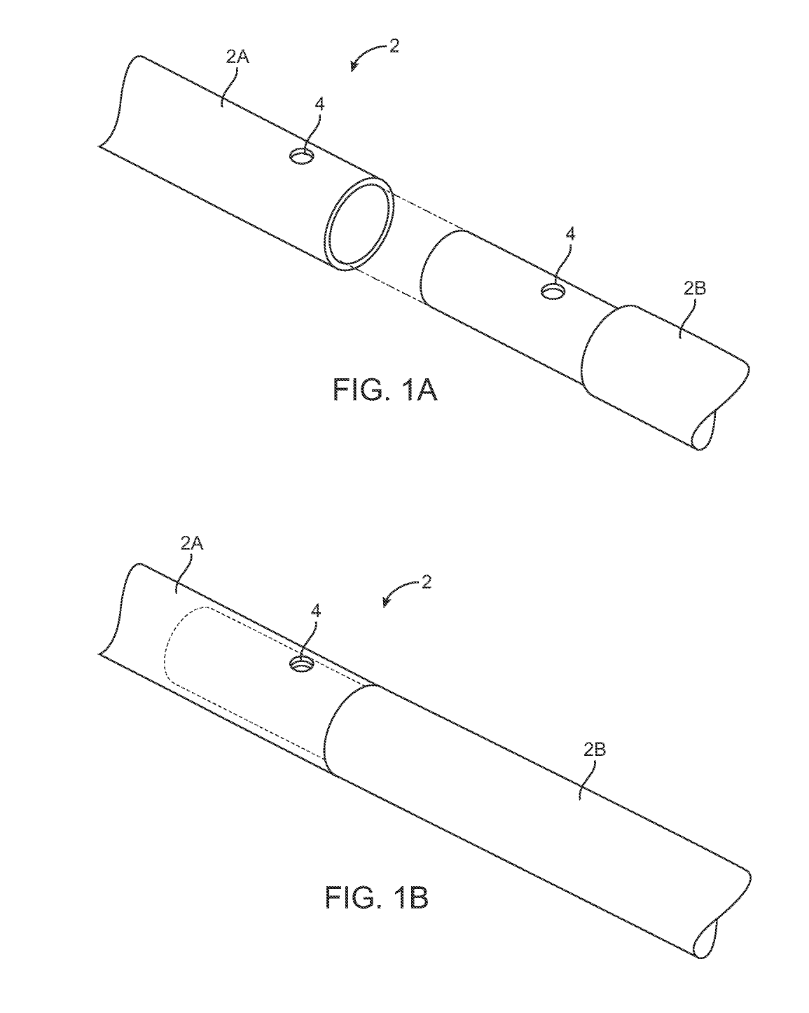

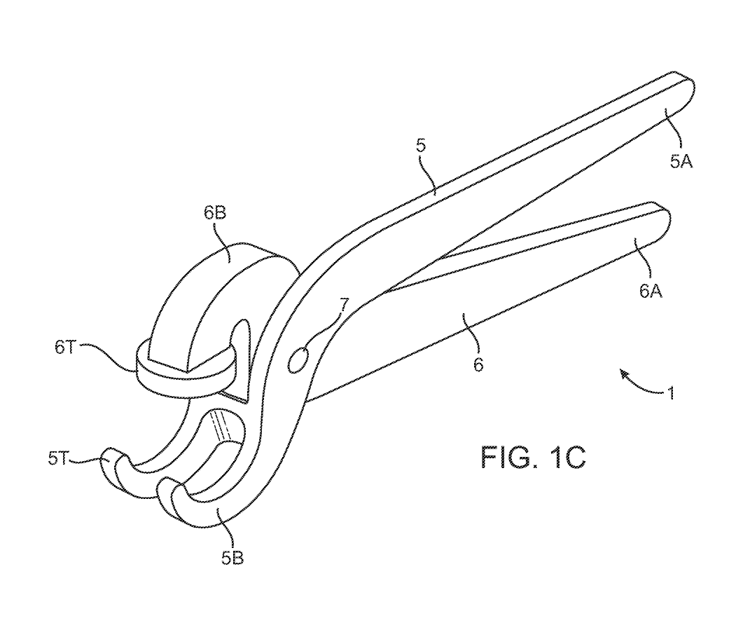

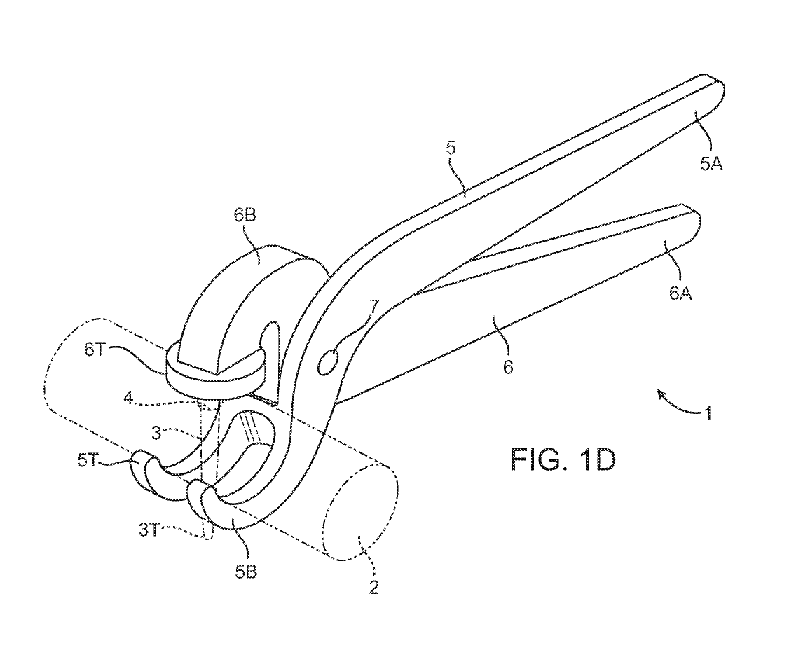

Referring now to the embodiments of the invention shown in the drawings, FIG. 1A illustrates examples of two unassembled truss pieces 2A, 2B that are assembled (interconnected) to form an assembled truss member 2 (FIG. 1B) using a truss assembly apparatus 1 (FIG. 1C), according to an embodiment of the present invention. Specifically, FIG. 1B illustrates a perspective view of the interconnected truss pieces 2A, 2B forming the truss member 2. In one example, the end portion of each truss piece 2A is conventionally tapered to either partially slidably fit into an end portion of another truss piece 2B, or partially slidably receive an end portion of another truss piece (e.g., a sleeve).

FIG. 1C illustrates a perspective view of the truss assembly apparatus 1, according to an embodiment of the present invention. The truss assembly apparatus 1 comprises a first lever 5 and a second lever 6 joined at a joint mechanism 7. In one embodiment, the joint mechanism comprises a pivot pin 7 which resides closer to an end of the levers 5 and 6. The first lever 5 further comprises a handle 5A at one end, and a head 5B at another end, wherein the pivot pin 7 resides closer to the head 5B. The second lever 6 further comprises a handle 6A at one end, and a head 6B at another end, wherein the pivot pin 7 resides closer to the head 6B. In one embodiment, the handles 5A and 6A are similar in shape, dimension, and reside towards the same end from the pivot pin 7.

FIG. 1D illustrates an alternative perspective view of the truss assembly apparatus 1 engaging a truss member 2 and a truss pin 3, according to an embodiment of the present invention. Truss systems comprise multiple truss members, wherein in one example each truss member 2 comprises an elongated cylindrical hollow tube. In one embodiment, each truss member 2 may have one or more holes 4 therethrough (i.e., essentially perpendicular to the long axis of the truss member) at various locations on the tube walls, preferably near each end of the truss member 2. The holes 4 have a diameter selected to allow receiving at least a portion of a truss pin 3.

The holes 4 on the so connected truss pieces 2A, 2B (forming truss member 2) are aligned to allow a truss pin 3 to at least partially pass there through, the holes 4 essentially perpendicular to the axis of the connected truss member 2. This action locks the truss pieces together to form the truss member, preventing one tube from sliding out from the other. The apparatus 1 allows the truss pin 3 to be driven into the holes 4 of the connected truss member 2 with sufficient force to properly engage the inner rims of said holes. Moving the first lever 5 and the second lever 6 towards each other (e.g., by gripping the handles 5A and 6A in one hand and squeezing them toward each other) causes the first head 5B and the second head 6B to move towards each other for the tip 6T to engage a tip/head 3H of the truss assembly pin 3T and drive the truss assembly pin 3T through holes 4 in the truss pieces 2A, 2B to form an assembled truss member 2 therefrom.

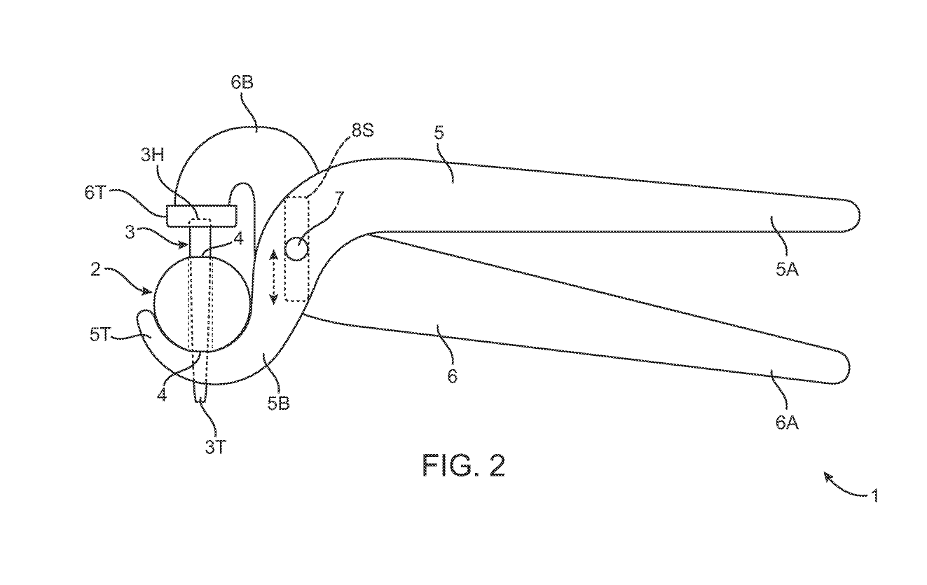

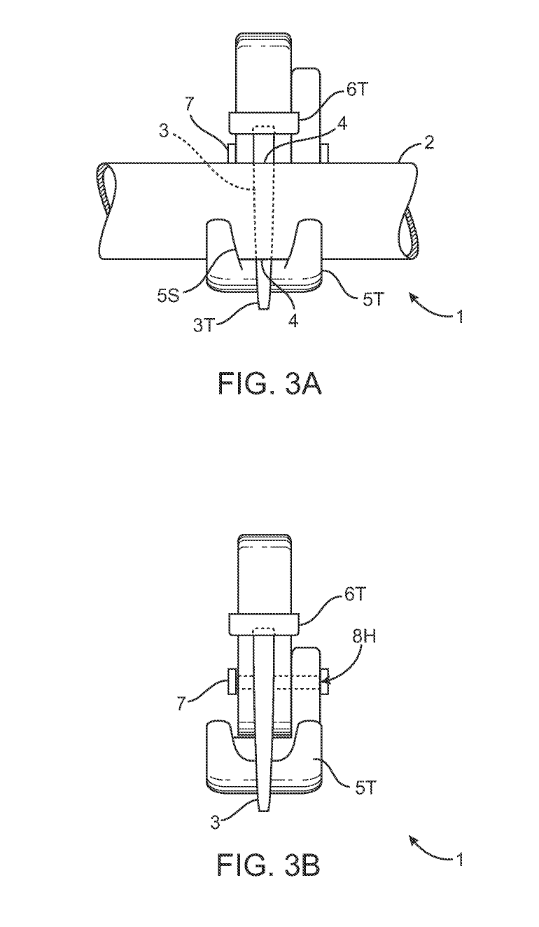

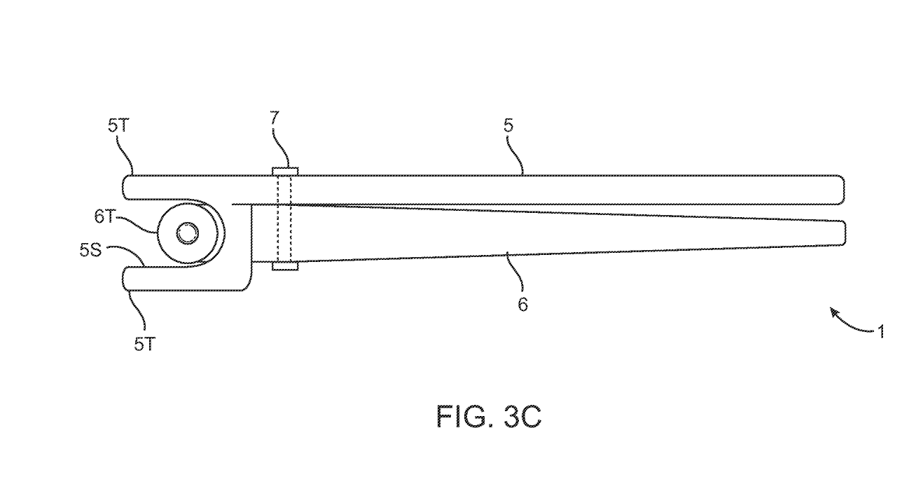

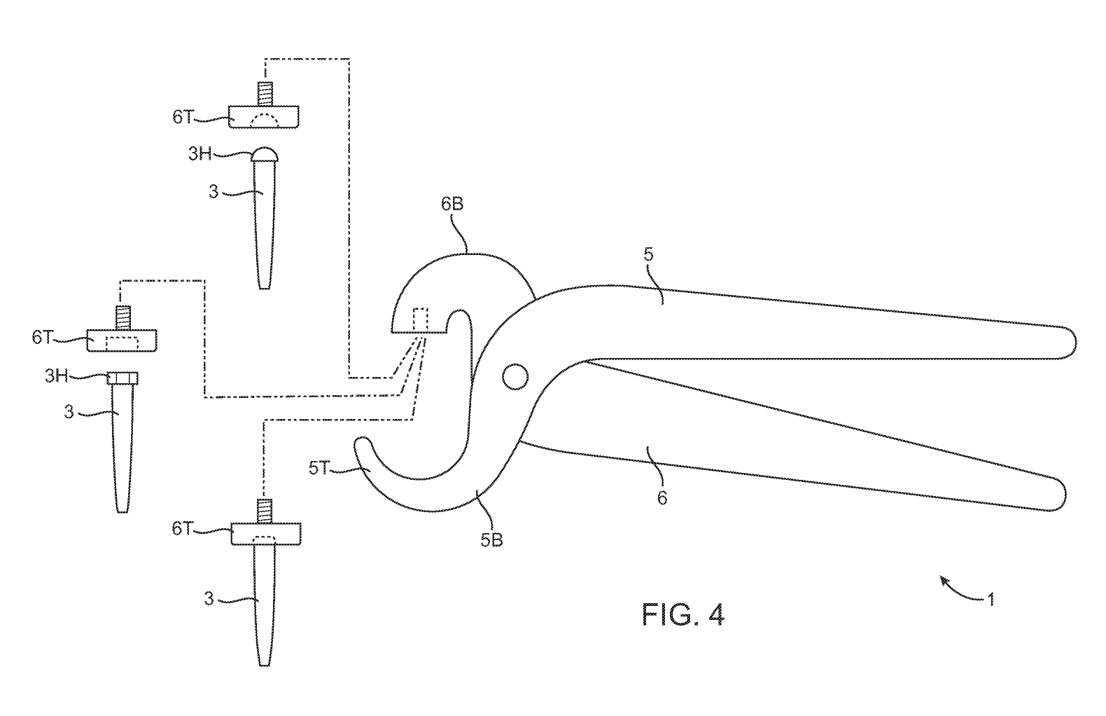

FIG. 2 illustrates a side view of the truss assembly apparatus 1 engaging the truss member 2 and the truss pin 3, according to an embodiment of the present invention. The head 6B is substantially curved (e.g., concave U-shape) in profile and residing in a plane essentially perpendicular to a plane of the lever handle 6A. The head 6B further comprises a tip 6T for engaging a head 3H of a truss pin 3. The tip 6T resides in a plane essentially parallel to the plane of the lever handle 6A. Additionally, the head 5B comprises a tip 5T for supporting a truss member 2. The tip 5T is substantially curved (e.g., convex U-shape) in profile and residing in a plane essentially perpendicular to a plane of the lever handle 5A. The tip 5T is capable of both receiving and supporting the walls of a truss member 2. The tip 5T further comprises an opening such as a slot 5S (FIG. 3A) allowing for at least the tip of the pin 3T to pass there through. In the example shown in FIG. 3A, the slot 5S is U-shaped.

As exemplified in FIG. 2, the tip 6T resides in a plane preferably perpendicular to the truss pin 3. It is also preferable that the truss member 2 resides in a plane perpendicular to both levers 5 and 6 and directly below tip 6T. In order to properly couple truss members together, each truss member 2 or the apparatus must be orientated so that the holes 4 reside in a plane parallel to the tip 6T.

The length of the handles 5A and 6A may be selected depending on the leveraging force desired for driving the truss pin 3 through the holes 4 in the truss member 2. The shape and size of the tip 5T may be selected to accommodate different truss member 2 shapes and sizes. Although example truss members 2 are shown as tubes with circular cross-section, other shape truss members may also be used (e.g., rectangular cross-section, elliptical cross-section, triangular cross-section). As such, the tip 5T may have different side profiles or cross sections (e.g., a rectangular, elliptical, triangular). Further, the handles 5A and 6A and pivoting mechanism may be of the adjustable ratchet type, slip joint type, groove joint or tongue-and-groove type, slotted channel type, etc., which allow adjusting the length of the handles 5A and 6A relative to the pivot pin 7, adjusting distance of the heads 6B and 5B for different leverage requirements, or allow moving of the heads 6B and 5B in a linear fashion.

As the handles 5A and 6A move towards each other, levers 5 and 6 pivot about the pin 7, thereby causing tips 5T and 6T to move towards each other. Conversely, as the handles 5A and 6A move away from each other, levers 5 and 6 pivot about the pin 7 causing tips 5T and 6T to move away from each other. When the handles 5A and 6A move towards each other, tip 6T exerts a force upon the pinhead 3H which in turn drives the truss pin 3 through the holes 4 in the truss member 2. Simultaneously, tip 5T exerts a force upon the walls of the truss member 2 which in turn prevents the truss member 2 from moving in a direction away from tip 6T. As the pinhead 3H nears the topmost hole 4 in the truss member 2, the pin tip 3T passes through the slot 5S (FIG. 3A) and extends in a direction below the head 5B.

FIG. 3A illustrates a front view of the truss assembly apparatus 1 engaging the truss member 2 and the truss pin 3, according to an embodiment of the present invention. FIG. 3B illustrates an alternative front view of the truss assembly apparatus 1, according to an embodiment of the present invention. In these figures, it is apparent that tips 5T and 6T reside in planes parallel to each other and perpendicular to the plane in which the pin 3 resides. Also exemplified in FIGS. 3A and 3B is the slot 5S in tip 5T. The slot 5S allows the pin 3 to extend in a direction below the tip 5T when driven through the truss member 2 (FIG. 3A). Referring now to FIG. 3A, it is clear that the convex shape of tip 5T abuts the walls of the truss member 2 and restricts said truss member 2 from rotating about the truss pin 3 during coupling.

In an alternative embodiment exemplified in FIG. 2 by ghost lines, the pivot pin 7 resides in an elongate channel 8S (shown by ghost lines) of the truss assembly apparatus 1, instead of a pivot hole 8H. The elongate channel 8S is orientated for allowing the pivot pin 7 to slide therein such that the levers 5 and 6 may move towards/away each other in a linear fashion, thereby allowing tips 5T and 6T to move towards/away each other in a linear fashion as shown by double headed arrow in ghost lines.

FIG. 3C illustrates a bottom view of the truss assembly apparatus 1, according to an embodiment of the present invention. In this view, the first lever 5 and second lever 6 meet at the pivot pin 7, and said pin 7 residing towards the tips 5T and 6T of the apparatus 1. The slot 5S is clearly visible which allows for the truss pin 3 to pass there through (FIG. 3B). It is also clear in this figure that tip 6T resides directly above tip 5T.

FIG. 4 illustrates an alternative side view of the truss assembly apparatus 1, according to an embodiment of the present invention. As shown, tip 6T may be detachable (e.g., threaded, screw on) such that different shape and size tips 6T may be attached to the head 6B. The different shape and size tips 6T are adapted to accommodate different shape and size pinheads 3H. A tip 6T may have a depression for receiving the head 3H of a pin 3, or may be flat, or may have a protrusion extending outwardly there from for engaging head of the pin 3, etc. Similar to tip 6T, in one embodiment tip 5T may be detachable from the head 5B (e.g., screw on), allowing the apparatus 1 to accommodate different shape or size truss members.

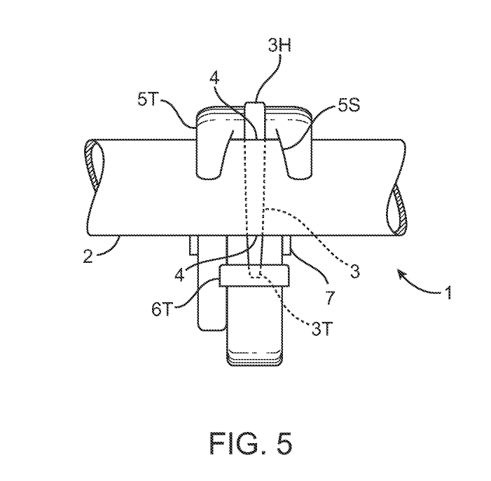

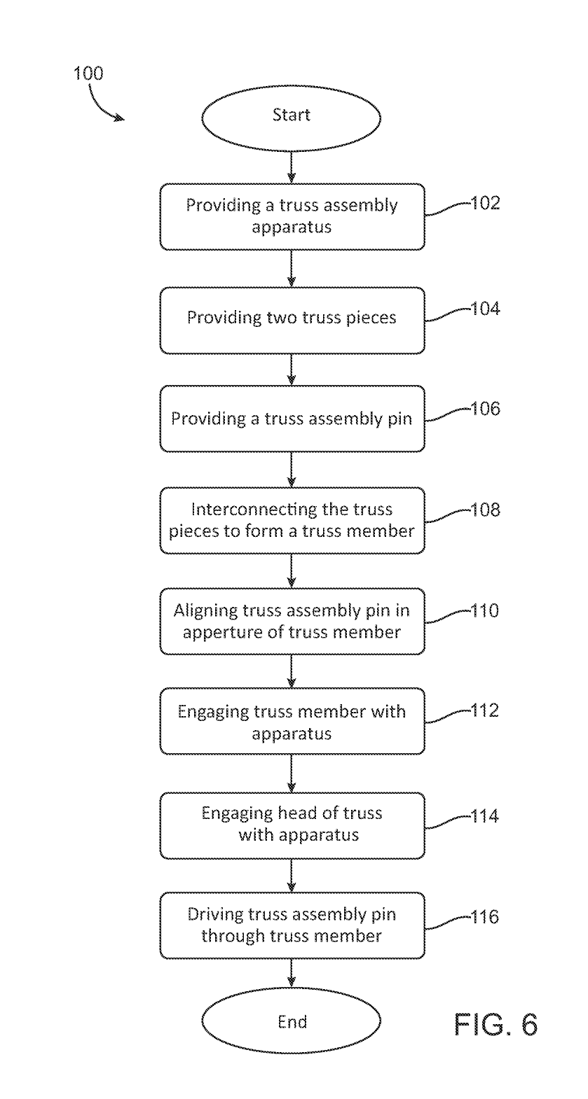

FIG. 5 illustrates a front view the truss assembly apparatus 1 engaging the truss member 2 and the truss pin 3, according to an embodiment of the present invention. While discussion thus far has been directed towards locking truss members together utilizing the truss assembly apparatus 1, said apparatus 1 can also facilitate the unlocking of truss members 2. By reversing the apparatus 1 so that the tip 6T contacts the pin tip 3T instead of the pinhead 3H, the apparatus 1 is capable of disengaging the truss pin 3 from the inner rims of the holes 4 in the truss member 2.

As the handles 5A and 6A move towards each other, levers 5 and 6 pivot about the pin 7, thereby causing tips 5T and 6T to move towards each other. Tip 6T exerts a force upon the pin tip 3T which in turn drives the truss pinhead 3H out of the holes 4 in the truss member 2. Simultaneously, tip 5T exerts a force upon the walls of the truss member 2 which in turn prevents the truss member 2 from moving in a direction away from tip 6T. As the pin tip 3T nears the topmost hole 4 in the truss member 2, the pinhead 3H passes through the slot 5S and extends in a direction below the head 5B, thus disengaging from the inner rims of the holes 4 in the truss member 2.

FIG. 6 illustrates a process 100 for coupling two truss pieces 2A, 2B (FIG. 1A) using the truss assembly apparatus 1 (FIG. 1C), according to an embodiment of the present invention. Process block 102 comprises providing the truss assembly apparatus 1 (FIG. 1C). After providing the apparatus,

Process block 104 comprises providing two truss pieces 2A, 2B (FIG. 1A). In this embodiment, the truss pieces 2A, 2B are separated but it will be appreciated that in alternative embodiments the truss pieces 2A, 2B may already be interconnected forming a truss member 2 (FIG. 1B).

After providing the truss assembly pin pursuant to process block 106, process block 108 comprises interconnecting the truss pieces 2A, 2B, to form a truss member 2 (FIG. 1B). As stated above, in an alternative embodiment, process block 104 may provide the two truss pieces 2A, 2B already interconnected forming truss member 2 (FIG. 1B). Regardless, after forming the truss member 2 (FIG. 1B), process 100 continues with process block 110 which comprises aligning the truss assembly pin 3 in holes 4 of the truss member 2 (FIG. 3A).

Process block 110 comprises aligning the holes 4 on the so connected truss pieces 2A, 2B (forming truss member 2) to allow the truss pin 3 to at least partially pass there through (FIG. 3A). Process block 110 is complete after aligning the truss pin with the holes.

Engaging the truss member with the truss assembly apparatus as per process block 112 comprises supporting the truss member 2 with the tip 5T of the head 5B (FIG. 2). After supporting the truss member 2, process block 112 is complete and the process 100 continues with process block 114 comprising engaging the pinhead 3H with the apparatus (FIG. 2); specifically the tip 6T of the head 6H engages the pinhead 3H. Afterwards, the process block 116 comprises driving the truss assembly pin 3 through the truss member 2 (FIG. 3A).

Driving the truss assembly pin 3 through the truss member 2 according to process block 116 entails moving handles 5A and 6A towards each other so that levers 5 and 6 pivot about the pin 7, thereby causing tips 5T and 6T to move towards each other (FIG. 2). As the handles 5A and 6A move towards each other, tip 6T exerts a force upon the pinhead 3H which in turn drives the truss pin 3 through the holes 4 in the truss member 2 (FIG. 2). Simultaneously, tip 5T exerts a force upon the walls of the truss member 2 which in turn prevents the truss member 2 from moving in a direction away from tip 6T. As the pinhead 3H nears the topmost hole 4 in the truss member 2, the pin tip 3T passes through the slot 5S (FIG. 3A) and extends in a direction below the head 5B. The process 100 ends after completion of step 116.

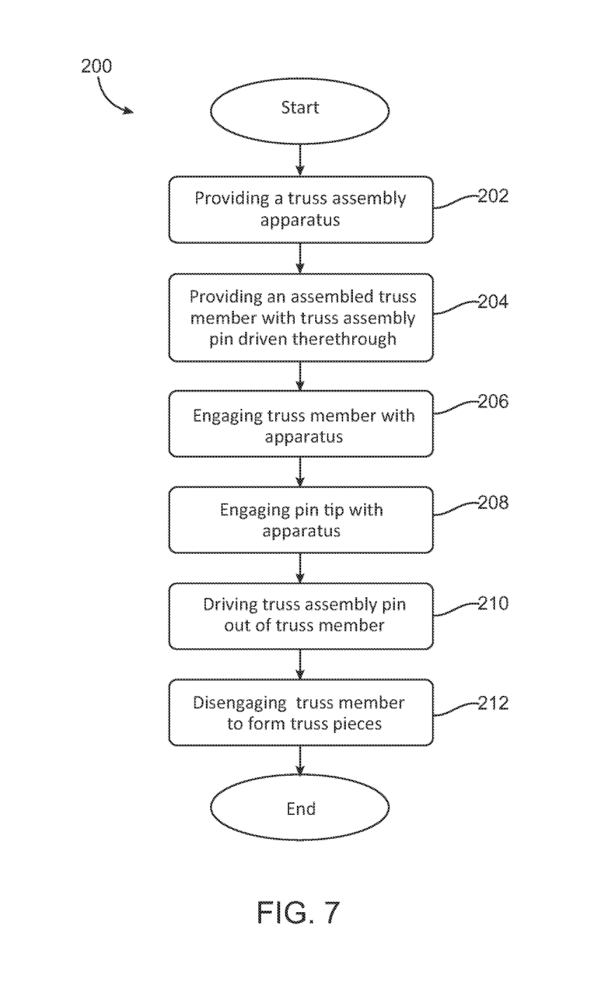

FIG. 7 illustrates a process 200 for de-coupling (disassembling) two previously assembled truss pieces 2A, 2B forming a truss member 2 (FIG. 1B) using the truss assembly apparatus 1 (FIG. 5), according to an embodiment of the present invention. The process 200 begins with process block 202 comprising providing a truss assembly apparatus 1 (FIG. 5). After providing the apparatus 1, the process 200 continues with process block 202 which comprises providing a truss member 2 that has a truss assembly pin 3 driven through holes 4 of the truss pieces 2A, 2B.

The truss member 2 formed from two separate truss pieces 2A, 2B (FIG. 1B) are held together by means of the truss pin 3. Process block 206 comprises engaging the truss member 2 with the apparatus 1 (FIG. 5), by supporting the truss member 2 with the tip 5T of the head 5B (FIG. 5). Process block 206 is complete after supporting the truss member 2. The process 200 continues with process block 208 comprising engaging the pin tip 3T with the apparatus (FIG. 5) wherein the tip 6T of the head 6H engages the pin tip 3T. Thereafter, the process 200 continues with process block 210 comprising driving the truss assembly pin 3 out of holes (4) in the truss member 2 (FIG. 5).

Driving the truss assembly pin out of holes in the truss member pursuant to process block 210 entails moving handles 5A and 6A of the apparatus 1 towards each other so that levers 5 and 6 pivot about the pin 7. As a result, tips 5T and 6T move towards each other; tip 6T exerts a force upon the pin tip 3T which in turn backs out the truss pinhead 3H out of the holes 4 in the truss member 2 (FIG. 5). Simultaneously, tip 5T exerts a force upon the walls of the truss member 2 which in turn prevents the truss member 2 from moving in a direction away from tip 6T. Process block 210 is complete when the pinhead 3H passes through the slot 5S and extends in a direction below the head 5B (FIG. 5).

Finally, process 212 comprises disengaging the truss member 2 to obtain two truss pieces 2A, 2B (FIG. 1A). In one embodiment, disengaging comprises pulling each end of the truss member 2 in an opposite direction so as to disconnect truss piece 1A and truss piece 2B (FIG. 1A). After disengaging the truss member 2 to form the two truss pieces 2A, 2B (FIG. 1A), the process 200 ends.

The present invention has been described in considerable detail with reference to certain preferred versions thereof; however, other versions are possible. Therefore, the spirit and scope of the appended claims should not be limited to the description of the preferred versions contained herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A truss assembly device, comprising:
a first lever and a second lever coupled together about a joint mechanism;
the first lever comprising:
a first handle residing at one end of the first lever; and
a first head residing at another end of the first lever;
the second lever comprising:
a second handle residing at one end of the second lever; and
a second head residing at another end of the second lever;
wherein the first head, the first handle, the second head, and the second handle pivot about the joint mechanism;
wherein the first head is substantially curved in a concave-upward profile configured for receiving a truss member; and
wherein the second head is configured for engaging and driving a truss assembly pin through holes in the truss member when the first lever and the second lever move towards each other thereby causing the first head and the second head to move towards each other.

2. The truss assembly device of claim 1, wherein the second head is substantially curved in a concave-downward profile, opposing the first head, configured for engaging and driving a truss assembly pin through holes in the truss member when the first lever and the second lever move towards each other thereby causing the first head and the second head to move towards each other.

3. The truss assembly device of claim 2, wherein the first head further comprises:
a first tip at an end of the first head, the first tip comprising: an opening allowing for at least a portion of the truss assembly pin to pass therethrough; and
wherein the concave-downward profile of the first head is configured for both receiving and supporting walls of the truss member.

4. The truss assembly device of claim 3, wherein the second head further comprises:
a second tip at an end of the second head; and
the second tip configured for engaging a head of the truss assembly pin.

5. The truss assembly device of claim 4, wherein the second tip is axially aligned with the opening such that second tip drives the truss assembly pin through the opening when the first lever and the second lever move towards each other thereby causing the first head and the second head to move towards each other.

6. The truss assembly device of claim 5, wherein the opening comprises a U-shaped slot in the first head.

7. The truss assembly device of claim 6, wherein:
the second tip is removably coupled to the end of the second head; and
the second tip is interchangeable to accommodate the head of the truss assembly pin having different shapes and/or dimensions.

8. The truss assembly device of claim 2, wherein:
the first head further comprises:
a first tip coupled to an end of the first head, the first tip comprising: an opening allowing for at least a portion of the truss assembly pin to pass therethrough;
the second head further comprises:
a second tip coupled to an end of the second head, wherein the second tip resides in a plane essentially parallel to a plane of the second handle;
the first head is substantially curved in a concave-upward profile and capable of both receiving and supporting walls of the truss member;
the second tip is configured for engaging a head of the truss assembly pin;
the second tip is removably coupled to the end of the second head; and
the second tip is interchangeable to accommodate the head of the truss assembly pin having different shapes and/or dimensions.

9. The truss assembly device of claim 1, wherein the joint mechanism comprises a pivot pin.

10. A truss assembly device, comprising:
a first lever and a second lever coupled together about a joint mechanism;
the first lever comprising:
a first handle at one end of the first lever; and
a first head at another end of the first lever, the first head being substantially curved in a concave-upward profile configured for both receiving and supporting walls of a truss member;
the second lever comprising:
a second handle at one end of the second lever; and
a second head at another end of the second lever, the second head being substantially curved in a concave-downward profile configured for driving a truss assembly pin through holes in the truss member;
a first tip coupled to an end of the first head, the first tip comprising:
a U-shaped slot configured for receiving and allowing at least a portion of the truss assembly pin to pass therethrough; and
a second tip removably coupled to an end of the second head, the second tip configured for engaging a head of the truss assembly pin, wherein the second tip is interchangeable to accommodate the head of the truss assembly pin having different shapes and/or dimensions;
wherein the first head, the first handle, the second head, and the second handle pivot about the joint mechanism.

11. The truss assembly device of claim 10, wherein:
the second tip is axially aligned with the U-shaped slot such that second tip drives the truss assembly pin through the U-shaped slot when the first lever and the second lever move towards each other thereby causing the first head and the second head to move towards each other; and
the joint mechanism comprises a pivot pin.

12. A method for coupling truss pieces, comprising:
providing a truss assembly apparatus, comprising:
a first lever and a second lever coupled together about a joint mechanism;
the first lever comprising:
a first handle at one end of the first lever; and
a first head at another end of the first lever;
the second lever comprising:
a second handle at one end of the second lever; and
a second head at another end of the second lever;
wherein the first head, the first handle, the second head, and the second handle pivot about the joint mechanism;
wherein the first head is substantially curved in a concave-upward profile and capable of receiving the truss member;
wherein the second head is substantially curved in a concave-downward profile, opposing the first head, and configured for engaging and driving a truss assembly pin through holes in truss pieces; and
moving the first lever and the second lever towards each other thereby causing the first head and the second head to move towards each other to drive a truss assembly pin through holes in the truss pieces to form an assembled truss member therefrom.

13. The method of claim 12, wherein the first head further comprises:
a first tip at an end of the first head, the first tip comprising:
an opening allowing for at least a tip of the truss assembly pin to pass therethrough;
the first head being substantially curved in a concave-upward profile configured for both receiving and supporting walls of the truss member.

14. The method of claim 13, wherein the second head further comprises:
a second tip at an end of the second head and the second tip residing in a plane essentially parallel to the plane of the second handle, the second tip configured for engaging a head of the truss assembly pin.

15. The method of claim 14, further comprising:
moving the first handle and second handle toward each other thereby causing the first head and second head to move towards each other;
wherein the first head exerts a force upon walls of the truss member; and
wherein the second tip exerts a force upon the head of the truss assembly pin thereby driving the truss assembly pin through holes in the truss member.

16. The method of claim 15, further comprising:
prior to driving the truss assembly pin: engaging the first head of the apparatus with the walls of the truss member.

17. The method of claim 16, further comprising:
prior to driving the truss assembly pin: engaging the second tip of the apparatus with the head of the truss assembly pin.

18. The method of claim 17, further comprising:
prior to driving the truss assembly pin: aligning the truss assembly pin with the holes in the truss member.

19. The method of claim 18, further comprising:
prior to aligning the truss assembly pin: interconnecting the first truss piece and the second truss piece-RB) to form the truss member.

20. The method of claim 19, wherein each truss piece comprises:
an elongate truss piece having an end portion being tapered to either partially slidably fit into an end portion of another truss piece, or partially slidably receive an end portion of another truss piece; and
at least a hole in wall of the truss piece at an end portion of the truss piece configured for allowing the truss assembly pin to pass at least partially therethrough;
wherein each holes is substantially perpendicular to an axis of the truss piece.

21. A method for coupling truss pieces, comprising:
providing a truss assembly apparatus, comprising:
a first lever and a second lever coupled together about a joint mechanism;
the first lever comprising:
a first handle at one end of the first lever; and
a first head at another end of the first lever;
the second lever comprising:
a second handle at one end of the second lever; and
a second head at another end of the second lever;
wherein the first head, the first handle, the second head, and the second handle pivot about the joint mechanism;
wherein the first head is substantially curved in a concave-upward profile and capable of receiving the truss member;
wherein the second head is substantially curved in a concave-downward profile, opposing the first head, and configured for engaging and driving a truss assembly pin through holes in truss pieces; and
moving the first lever and the second lever towards each other thereby causing the first head and the second head to move towards each other to drive a truss assembly pin through holes in the truss pieces to form an assembled truss member therefrom;
wherein the first head further comprises:
a first tip at an end of the first head, the first tip comprising:
an opening allowing for at least a tip of the truss assembly pin to pass therethrough;
the first head being substantially curved in a concave-upward profile configured for both receiving and supporting walls of the truss member;
wherein the second head further comprises:
a second tip at an end of the second head and the second tip residing in a plane essentially parallel to the plane of the second handle, the second tip configured for engaging a head of the truss assembly pin.

22. The method of claim 21, wherein moving the first lever and the second lever towards each other further comprises:
moving the first handle and second handle toward each other thereby causing the first head and second head to move towards each other;
wherein the first head exerts a force upon walls of the truss member; and
wherein the second tip exerts a force upon the head of the truss assembly pin thereby driving the truss assembly pin through holes in the truss member;
wherein prior to driving the truss assembly pin: engaging the first head of the apparatus with the walls of the truss member;
wherein prior to driving the truss assembly pin: engaging the second tip of the apparatus with the head of the truss assembly pin;
wherein prior to driving the truss assembly pin: aligning the truss assembly pin with the holes in the truss member;
wherein prior to aligning the truss assembly pin: interconnecting the first truss piece and the second truss piece-PB) to form the truss member;
wherein each truss piece comprises:
an elongate truss piece having an end portion being tapered to either partially slidably fit into an end portion of another truss piece, or partially slidably receive an end portion of another truss piece; and
at least a hole in wall of the truss piece at an end portion of the truss piece configured for allowing the truss assembly pin to pass at least partially therethrough;
wherein each holes is substantially perpendicular to an axis of the truss piece.

23. A method for de-coupling an assembled truss member, comprising:
providing a truss assembly apparatus, comprising:
a first lever and a second lever coupled together about a joint mechanism;
the first lever comprising:
a first handle at one end of the first lever; and
a first head at another end of the first lever;
the second lever comprising:
a second handle at one end of the second lever; and
a second head at another end of the second lever;
wherein the first head, the first handle, the second head, and the second handle pivot about the joint mechanism;
wherein the first head is substantially curved in a concave-upward profile and capable of receiving the truss member;
wherein the second head is substantially curved in a concave-downward profile, opposing the first head, and configured for engaging and driving a truss assembly pin out of holes in the assembled truss member; and
moving the first lever and the second lever towards each other thereby causing the first head and the second head to move towards each other to drive a truss assembly pin out of holes in the assembled truss member.

24. The method of claim 23, wherein the first head further comprises:
a first tip at an end of the first head, the first tip comprising:
an opening allowing for at least a head of the truss assembly pin to pass therethrough;
the first head being substantially curved in a concave-upward profile configured for both receiving and supporting walls of the truss member.

25. The method of claim 24, wherein the second head further comprises:
a second tip at an end of the second head and the second tip residing in a plane essentially parallel to the plane of the second handle, the second tip configured for engaging a tip of the truss assembly pin.

26. The method of claim 25, further comprising:
moving the first handle and second handle toward each other thereby causing the first head and second head to move towards each other;
wherein the first head exerts a force upon walls of the truss member; and
wherein the second tip exerts a force upon the tip of the truss assembly pin thereby driving the truss assembly pin out of holes in the assembled truss member.

27. The method of claim 26, further comprising:
prior to driving the truss assembly pin out of the truss member: engaging the first head of the apparatus with the walls of the truss member.

28. The method of claim 27, further comprising:
prior to driving the truss assembly pin out of the truss member: engaging the second tip of the apparatus with the tip of the truss assembly pin.

29. The method of claim 28, further comprising:
disengaging the truss member to obtain a first truss piece and a second truss piece.

30. The method of claim 29, wherein each truss piece comprises:
an elongate truss piece having an end portion being tapered to either partially slidably fit into an end portion of another truss piece, or partially slidably receive an end portion of another truss piece; and
at least a hole in wall of the truss piece at an end portion of the truss piece configured for allowing the truss assembly pin to pass at least partially therethrough;
wherein each holes is substantially perpendicular to an axis of the truss piece.

31. A method for de-coupling an assembled truss member, comprising:
providing a truss assembly apparatus, comprising:
a first lever and a second lever coupled together about a joint mechanism;
the first lever comprising:
a first handle at one end of the first lever; and
a first head at another end of the first lever;
the second lever comprising:
a second handle at one end of the second lever; and
a second head at another end of the second lever;
wherein the first head, the first handle, the second head, and the second handle pivot about the joint mechanism;
wherein the first head is substantially curved in a concave-upward profile and capable of receiving the truss member (2);
wherein the second head is substantially curved in a concave-downward profile, opposing the first head, and configured for engaging and driving a truss assembly pin out of holes in the assembled truss member; and
moving the first lever and the second lever towards each other thereby causing the first head and the second head to move towards each other to drive a truss assembly pin out of holes in the assembled truss member;
wherein the first head further comprises:
a first tip at an end of the first head, the first tip comprising:
an opening allowing for at least a head of the truss assembly pin to pass there through;
the first head being substantially curved in a concave-upward profile configured for both receiving and supporting walls of the truss member;
wherein the second head further comprises:
a second tip at an end of the second head and the second tip residing in a plane essentially parallel to the plane of the second handle, the second tip configured for engaging a tip of the truss assembly pin;

32. The method of claim 31, further comprising:
moving the first handle and second handle toward each other thereby causing the first head and second head to move towards each other; and
disengaging the truss member to obtain a first truss piece and a second truss piece;
wherein the first head exerts a force upon walls of the truss member; and
wherein the second tip exerts a force upon the tip of the truss assembly pin thereby driving the truss assembly pin out of holes in the assembled truss member;
wherein prior to driving the truss assembly pin out of the truss member: engaging the first head of the apparatus with the walls of the truss member;
wherein prior to driving the truss assembly pin out of the truss member: engaging the second tip of the apparatus with the tip of the truss assembly pin;
wherein each truss piece comprises:
an elongate truss piece having an end portion being tapered to either partially slidably fit into an end portion of another truss piece, or partially slidably receive an end portion of another truss piece; and
at least a hole in wall of the truss piece at an end portion of the truss piece configured for allowing the truss assembly pin to pass at least partially therethrough;
wherein each holes is substantially perpendicular to an axis of the truss piece.

33. The truss assembly device of claim 4, wherein:
the second tip resides in a plane essentially perpendicular to a plane of the truss assembly pin when the second tip engages a head or a tip of the truss assembly pin; and
the first tip abuts the walls of the truss member and restricts the truss member from rotating.

34. The truss assembly device of claim 5, wherein:
the second tip is configured for:
engaging a head of the truss assembly pin and driving the truss assembly pin through the holes in the truss member.

35. The truss assembly device of claim 34, wherein:
the second tip is further configured for engaging a tip of the truss assembly pin and driving the truss assembly pin out of the holes in the truss member.

36. The truss assembly device of claim 1, wherein:
the first head and the second head move towards each other when the first handle and the second handle move towards each other.

37. The truss assembly device of claim 9, wherein the joint mechanism further comprises:
an elongate channel shaped to allow the pivot pin to slide therein, such that the first lever and the second lever can move towards each other or move away from each other linearly.
